(19) United States
(12) Patent Application Publication
(10) Pub. No.: US 2025/0265145 A1
(43) Pub. Date: Aug. 21, 2025

(54) REFINED HARD BIT READ VOLTAGES

(71) Applicant: Microchip Technology Incorporated, Chandler, AZ (US)

(72) Inventors: Nian Niles YANG, Mountain View, CA (US); Pitamber SHUKLA, San Jose, CA (US); Murthy HARI, San Jose, CA (US)

(21) Appl. No.: 19/017,648

(22) Filed: Jan. 11, 2025

Related U.S. Application Data
(60) Provisional application No. 63/555,888, filed on Feb. 20, 2024.

(51) Int. Cl. G06F 11/10

(52) U.S. Cl. CPC G06F 11/1016; G06F 11/1068

(57) ABSTRACT

In some implementations, a storage device may perform a read operation to obtain data stored on the storage device performing a decoding operation on the data. The storage device may identify a refined hard bit read voltage based on constructed data. The storage device may apply the refined hard bit read voltage. In some aspects, the storage device may use the refined hard bit read voltage to determine bit values of the storage device in a subsequent decoding operation associated with a subsequent read operation.

### CROSS-REFERENCE TO RELATED APPLICATION

This Patent Application claims priority to Provisional Patent Application No. 63/555,888 filed on Feb. 20, 2024, and entitled “REFINED HARD BIT READ VOLTAGES.” The disclosure of the prior Provisional Patent Application is considered part of and is incorporated by reference into this Patent Application.

### FIELD

The present disclosure generally relates to adjusting a hard bit read voltage during a decoding operation. The storage device (e.g., a controller of the storage device) may adjust a hard bit read voltage to obtain a refined hard bit read voltage, with the adjustment based on a soft bit decoding operation performed, after failure of a hard bit decoding operation, on read voltages obtained in a read operation. The storage device may use the refined hard bit read voltage in a subsequent hard bit decoding operation.

### BACKGROUND

A non-volatile memory device may include a storage device (e.g., a memory device) that may store and retain data without external power supply. One example of a non-volatile memory device is a NOT-AND (NAND) flash memory device.

The storage device may store data as bits within the storage device. For example, the storage device may include transistors that store bit values. Transistors may store the bit values based on applying a voltage to an active area of the transistor, which voltage changes a state of the active area.

To read the data, the storage device may perform a read operation. The read operation may include applying a hard bit read input voltage to the transistors and measuring (e.g., sensing) output voltages of the transistors. The output voltages of the transistors may be compared with a hard bit read voltage (e.g., a threshold) to identify bit values of respective transistors. For example, if an output voltage of a transistor is above (e.g., inclusive or exclusive) the hard bit read voltage, then the transistor may give a value of “1.” Alternatively, if an output voltage of a transistor is below (e.g., inclusive or exclusive) the hard bit read voltage, then the transistor may give a value of “0.”

If a hard bit decoding fails (e.g., based on a parity check or other indicator), the storage device may perform soft bit decoding. Soft bit decoding may involve an iterative process of testing different values for cell associated with a read operation. For example, the controller may test a parity check when switching values from a “1” to a “0” or vice versa. The controller may switch values for output voltages (e.g., read voltages) that are within a threshold of the hard bit read voltage.

### SUMMARY

In some implementations, a method performed by a storage device includes performing a read operation to obtain data stored on the storage device. The method may further include performing a decoding operation on the data. The method may further include identifying a refined hard bit read voltage based on constructed data. The method may further include applying the refined hard bit read voltage.

In some implementations, a system comprises a controller of a non-volatile memory device. The controller may perform multiple read operations to obtain data stored on the storage device. The controller may perform a decoding operation on the data. The controller may generate constructed data using the multiple read operations and the decoding operation. The controller may identify a refined hard bit read voltage based on constructed data. The controller may apply the refined hard bit read voltage.

In some implementations, a computer program product comprises one or more computer readable storage media and program instructions collectively stored on the one or more computer readable storage media. The program instructions comprise program instructions to perform at least a first read operation to obtain a first set of bit values for data stored on the storage device and a second read operation to obtain a second set of bit values for the data. The program instructions comprise program instructions to perform a decoding operation on the data to identify locations of conflicting bit values from the first read operation and the second read operation. The program instructions comprise program instructions to generate constructed data using bit values of the first read operation at locations without conflicting bit values and using bit values of the second read operation at locations having conflicting bit values. The program instructions comprise program instructions to decode the data based at least in part on the first bit values, the second bit values, and the constructed data.

### BRIEF DESCRIPTION OF THE DRAWINGS

FIGS. 1A-1E and 2 are diagrams of examples of refining hard bit read voltages described herein.

FIGS. 3 and 4 are diagrams of example components of one or more devices used in conjunction with FIG. 1 or 2.

FIGS. 5-7 are flowcharts of an example process associated with refining hard bit read voltages described herein.

### DETAILED DESCRIPTION

The following detailed description of example implementations refers to the accompanying drawings. The same reference numbers in different drawings may identify the same or similar elements.

A non-volatile memory device (e.g., a negative-and (NAND) memory device) that may store data that is accessible via a controller. The controller may include one or more of an application specific integrated circuit (ASIC) or firmware. In some examples, the non-volatile memory device and the controller may be included in a solid-state drive (SSD).

Data storage on a storage device (e.g., a non-volatile memory device) may be associated with errors. For example, data stored on the storage device may be stored in physical elements of transistors or other binary storage units. To store a bit of data (using a write function) within the storage device, the controller may apply a voltage to a transistor that changes a state of the transistor to be read as a 1 or a 0 when using a read function to apply a read voltage. Because the application of voltage is analog (e.g., not a simple 1 or 0), the application of voltages in a read or write cycle may not be perfect or a reading may not be perfect, which may cause errors in the data.

Additionally, over time and write-read-erase cycles, storage on the storage device may degrade based on degradation of physical components of the transistors or connected devices. For example, insulating materials, channel materials, gates, or conductive layers may interact to degrade barriers used to form current paths and voltage storage within the storage device.

During read operations (e.g., an SSD read operation), a bit error rate (BER) of a page read will increase due to various reasons, such as read disturb, data retention, endurance degradation, and interface signal skews, among other examples. If the BER can be corrected by a hard bit read (HBR), the storage device may avoid a failure of a read quality of service (QoS) issue. The HBR may use a hard bit read voltage that is indicated in a standard or static read level table (e.g., a static table that indicates threshold voltages to be used for the HBR).

An HBR refers to a process of reading bits from a storage medium based on comparing a sensed voltage of the storage medium (e.g., at one or more cells of the storage medium) with a threshold voltage (e.g., a hard bit read voltage). For example, the storage device (e.g., a controller of the storage device) may use the threshold voltage to determine whether a cell is read as a 1 or 0 (e.g., a sensed voltage below the threshold may be a 0 and a sensed voltage above the threshold may be a 1).

However, the BER may increase to a level where a soft bit read (SBR) is helpful, using low-density parity check (LDPC) correction with soft bit information and an associated log-likelihood-ratio (LLR). A SBR is more complex than an HBR with additional information read from the storage medium. In some examples, the SBR may provide finer granularity when indicating a sensed voltage, rather than a simple 1 or 0 (higher or lower than the threshold voltage). For example, an SBR may include information associated with a probability of a bit value or a multi-level representation of the sensed voltage (e.g., comparing a sensed voltage to fractional reference voltages in addition to the HBR threshold voltages). In some storage devices, an SBR may provide an indication of a likelihood of a cell having a bit value (0 or 1 in an SLC) based at least in part on the sensed voltage of the cell (e.g., a cell has a 75% likelihood of being a 1 based at least in part on a sensed voltage being between a first threshold voltage and a second threshold voltage). The storage device can perform error correction (e.g., using an error correction code) and test different hypotheses about values of the cells based at least in part on the likelihoods of values of the cells.

In some examples, at least 3 SBRs are utilized, including the HBR and two additional reads. For example, a first of the two additional reads may include a read level shifted to the left, and a second of the two additional reads may include a read level shifted to the right, with respect to a level of a hard bit read voltage.

Once the SBR has passed the decoding, the data may be provided to a requester (e.g., a host device) with some amount of QoS penalty, depending on if the SBR is inline or out of band. For example, if the SBR is out of band, more out of order reads may be used and thus more penalty of QoS may incur.

In some aspects described herein, the hard bit read voltage may be adjusted based on a SBR of a previous read operation. In this way, a subsequent read operation may avoid repeating a QoS failure or penalty by increasing a likelihood that an HBR is successful.

In some aspects, the operations described herein may assist in in-flight (e.g., during a read operation) redefined (e.g., improved) read level acquisition. As part of the SBR, a likelihood of a read exception increases as the storage device (e.g., an SSD storage device) becomes large in terms of capacity. Thus, the operations may efficiently reduce subsequent read failures because newer (and more accurate) read levels can be made available as soon as a read error handling has happened in the flight (e.g., during or after a read operation and a decoding operation are completed or while ongoing). For example, the controller may combine existing soft bit read information with extraction of a redefined (e.g., improved) read level into one operation. In this way, the controller may use the redefined read level and the soft bit read information to modify likelihoods of different bit values of cells.

In some aspects, an XOR operation may be used alongside regular error correction code decoding. In some aspects, an ASIC (e.g., associated with the controller) may compute newly added XOR data (e.g., from SBR or HBR) in a cumulative way to identify the refined hard bit read voltage. In some aspects, no background operation (e.g., outside of active read operations or decoding operations) may be utilized to test hard bit read voltages.

In some aspects, based on using refined hard bit read voltages, the storage device may improve the reliability of the storage device, reduce an uncorrectable BER (UBER), improve the read QoS, reduce system complexity, and improve user experience.

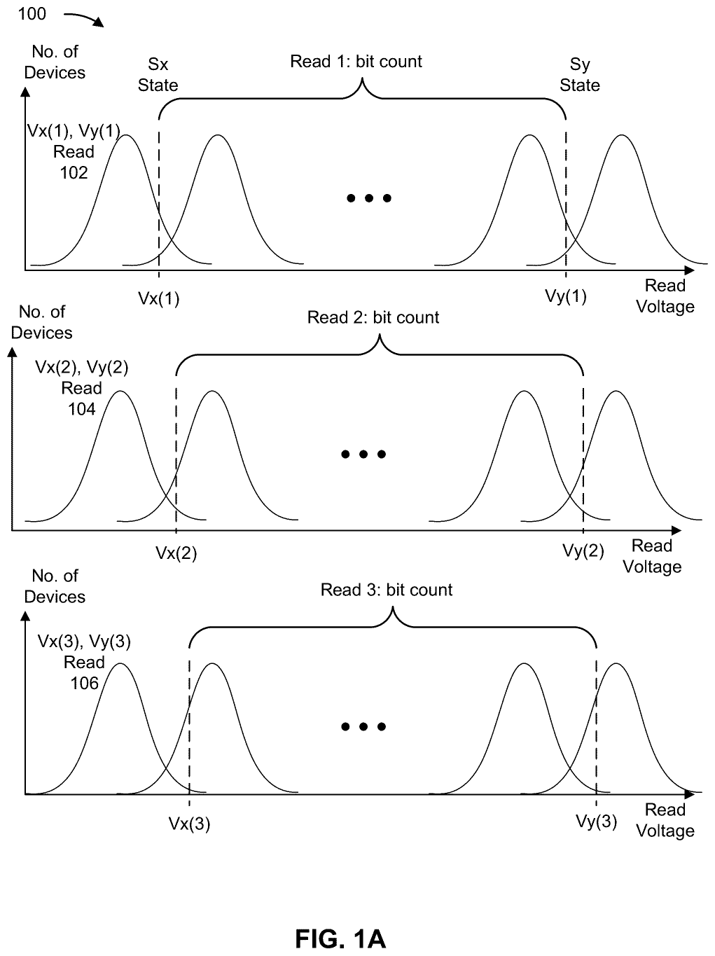

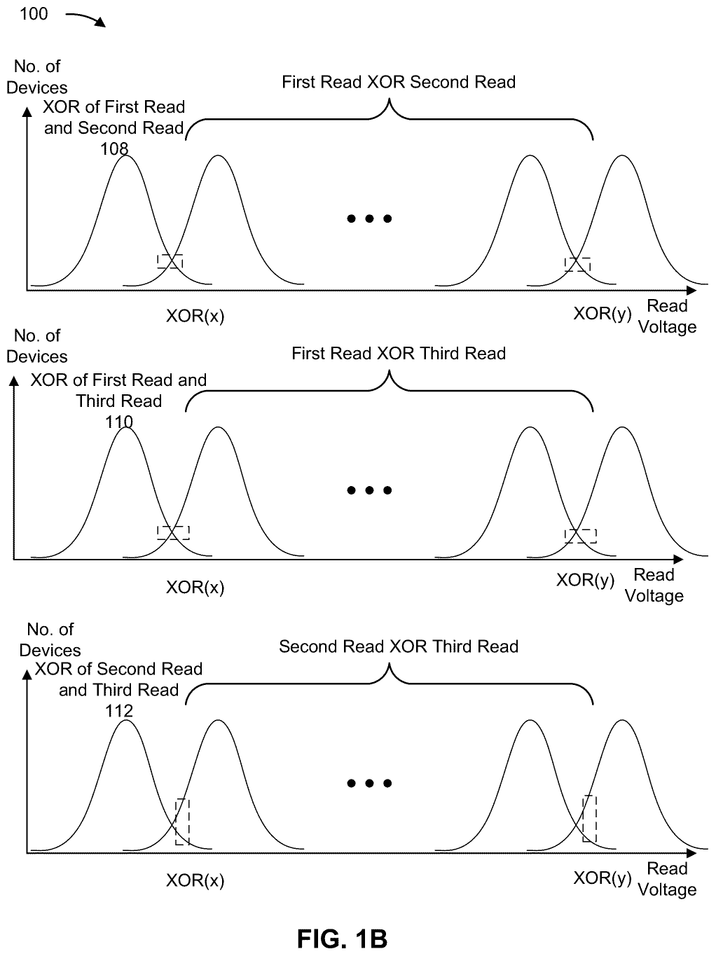

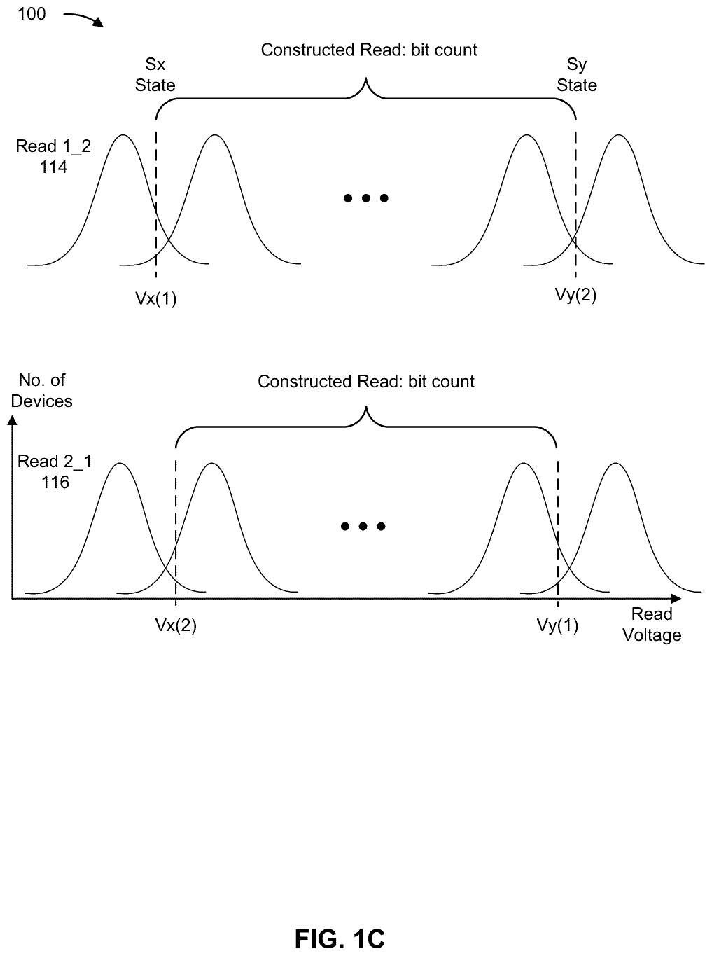

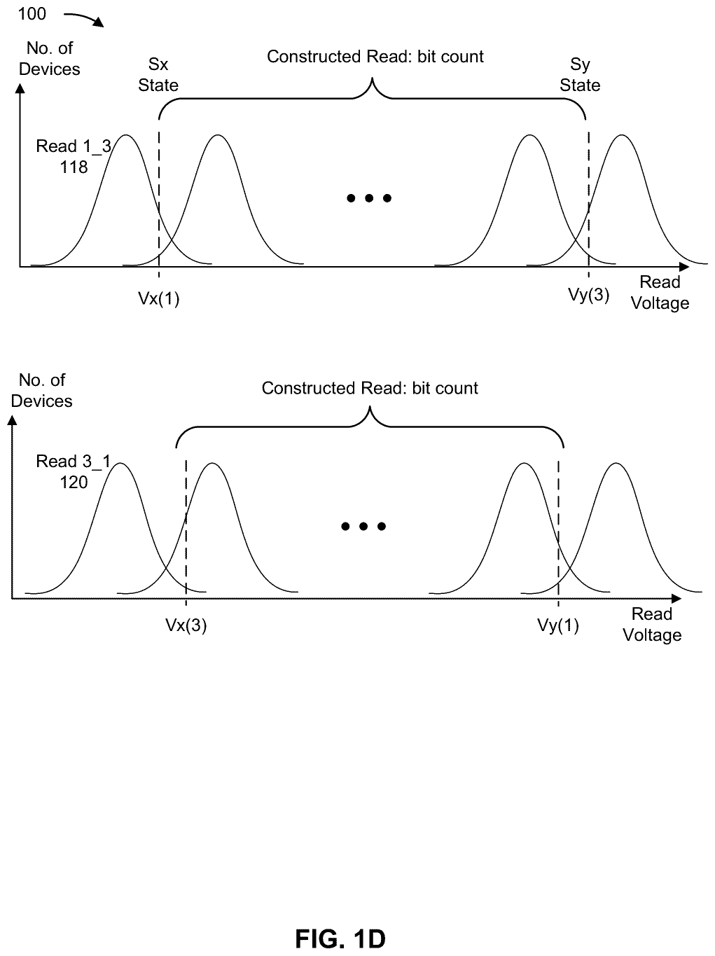

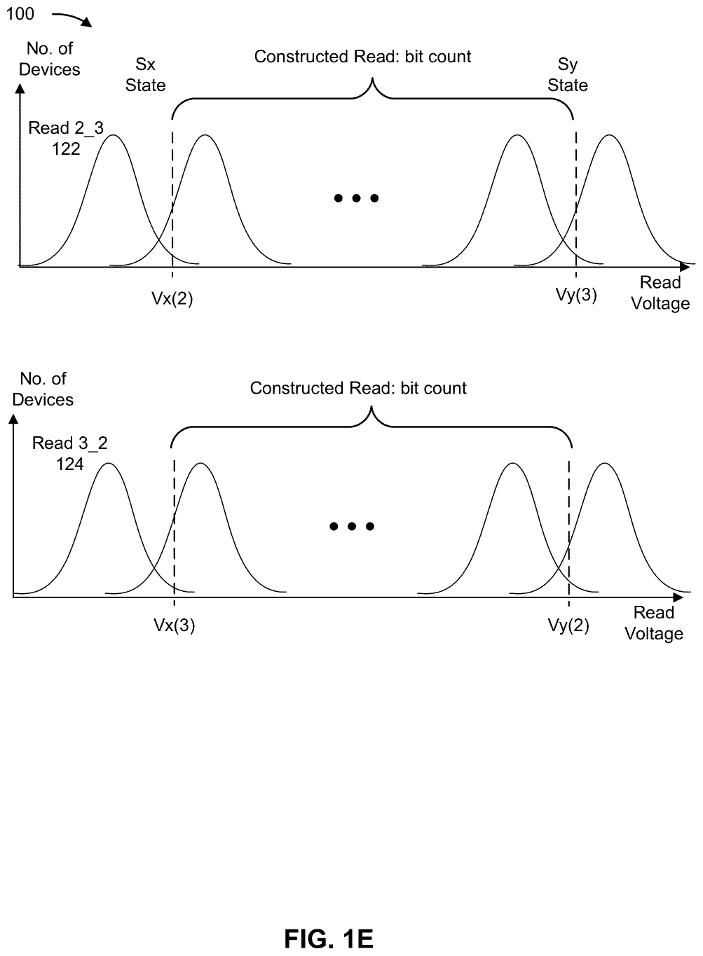

FIGS. 1A-1D are diagrams of an example 100 of refining hard bit read voltages described herein. The operations described in connection with example 100 may be performed by a storage device (e.g., a controller or application specific integrated circuit (ASIC) associated with the storage device, among other examples). Operations shown and described in connection with FIGS. 1A-1D may be understood in the context of a storage media, such as an SSD, a NAND device, or other storage devices. In example 100, the storage device may be configured to perform a 2-state read (e.g., a triple-level cell, lower page (LP), or upper page (UP) read, among other examples). A two state read is associated with determining whether a cell is associated with a first or second of two states (0 or 1). This may be associated with an SLC storage scheme.

Example 100 shows read voltage distributions, with a y axis indicating a quantity of cells (e.g., devices) and the x axis indicating a sensed voltage of corresponding cells. The x axis shows an example of two voltage thresholds Vₓ and V_{y}. These voltage thresholds are used by the storage device to determine what bit value to assign to a sensed value of a cell. In some aspects, a single cell may have four states (00, 01, 10, or 11 in an MLC configuration), eight states (000, 001, 010, 011, 100, 101, 111 in an TLC configuration), or more states. In these cells, ranges of voltages on the x axis are associated with different states and bit values of the cell. For example, a single state of the cell may exist between Vₓ and V_{y} or multiple states may exist between Vₓ and V_{y} with one or more additional voltage thresholds between them. Similarly, one or more states may exist below Vₓ and one or more states may exist above Vy.

In some aspects, storage media are configured with bit lines and word lines (arranged orthogonally to the bit lines). In this way, a first cell of a first bit line, a first cell of a second bit line, a first cell of a third bit line, etc. may form a word line that stores data. Based at least in part on physical characteristics of bit lines, one bit line may store a voltage associated with a first state at a different voltage value than a second bit line. This may cause the storage device to sense different voltage values associated with a same cell state at different locations of the storage media. The storage device may allow for the variance in voltage values based at least in part on assigning ranges of voltage values to individual cell states. However, some voltages intended to store a first state at a cell may vary too much to be read as the first state and may instead be read as a second state, which introduces error to a read operation.

In some aspects, the storage device may correct the errors using an error correction code scheme. However, the storage device may also attempt to read the cells using different threshold voltage values that separate the states of the cells. For example, the storage device may attempt to read the cells using values of Vₓ(1), Vₓ(2), and Vₓ(3) shown in FIG. 1A as different values of Vₓ. Similarly, the storage device may attempt to read the cells using values of V_{y}(1), V_{y}(2), and V_{y}(3) shown in FIG. 1A as different values of V_{y}.

However, repeated reads of the storage medium has a cost in terms of computing resources and latency. For this reason, the storage device may attempt to use constructed reads rather than physical reads of the storage medium to generate additional metrics to use for decoding read data and identifying improved voltage thresholds between cell states.

As shown in FIG. 1A, a storage device (e.g., a controller of the storage device) may perform multiple reads of a set of data stored on a storage medium of the storage device (e.g., on cells of the storage medium). States X and Y are two example memory states of the memory cell array after programming. Vₓ is a sensing voltage to be applied to the memory cell to know if a cell is in state “X”. V_{y} is a sensing voltage to be applied to the memory cell to know if a cell is in state “Y”. The storage device may obtain a Vₓ(1) (a first voltage associated with the X state), V_{y}(1) (a first voltage associated with the Y state) read 102 that includes values of bits at the storage medium using Vₓ(1) for an Sₓ state (associated with a first bit value) and using V_{y}(1) at an S_{y} state (associated with a second bit value). The storage device may obtain a Vₓ(2) (a second voltage associated with the X state), V_{y}(2) (a second voltage associated with the Y state) read 104 that includes values of bits at the storage medium using Vₓ(2) for the Sₓ state and using V_{y}(2) at the S_{y} state. The storage device may obtain a Vₓ(3) (a third voltage associated with the X state), V_{y}(3) (a third voltage associated with the Y state) read 106 that includes values of bits at the storage medium using Vₓ(3) for the Sₓ state and using V_{y}(3) at the S_{y} state.

In the context of FIGS. 1A-1D, Vₓ(1) and V_{y}(1) are voltages applied to a word line that may control tens of thousands of memory cells. Reference numbers 102, 104, and 106 represent operations to collectively identify how many memory cells are able to be sensed and detected under each voltage along the sensing word line. For state Sₓ, Vₓ sensing may identify how many memory cells of the sensing word line have a threshold above Vₓ. Therefore, 102, 104, and 106 may identify a number of cells at Vₓ(1), Vₓ(2), and Vₓ(3) and the in between Vₓ(1) and Vₓ(2) and Vₓ(2) and Vₓ(3), etc. This is referred to as a bit count of read 1, 2, 3, etc. Once the storage device has obtained the bit count reads, the storage device may perform operations described herein to reconstruct the read data using a reduced number of reads.

In this way, the storage device (e.g., a controller) may obtain three read levels at a state Sₓ at Vₓ(1, 2, 3) and three read levels at state S_{y} at V_{y}(1, 2, 3). The three levels may be used to improve read accuracy (e.g., to lower BER). However, increasing a number of reads may improve selections of read levels at Sₓ and at S_{y} for reducing BER.

As shown in FIG. 1B, the storage device may perform an XOR operation on the reads 102, 104, and 106 in different combinations to obtain XOR results from the combinations. The XOR operation is a logical operation that identifies where a same bit differs in value between reads. For example, an nth bit of the data has a first value during the first read associated with Vₓ(1) and a second value during the second read associated with the Vₓ(2). The XOR operation indicates whether the first value is the same as the second value (e.g., with an XOR value of 0) or different from the second value (e.g., with an XOR value of 1).

As shown in FIG. 1B, ranges of read voltages labeled as XOR(x) or XOR(y) indicate where a read bit value would change based on changing a voltage Vₓ or V_{y} from one read to another. For example, changing Vₓ (the threshold that divides a reading of a state of cells from a first state below to Vₓ to a second state above Vₓ) from the Vₓ(1) of read 102 to the Vₓ(2) of read 104 would change read bit values from a first bit value to a second bit value if a read voltage is within the range between Vₓ(1) and Vₓ(2).

In some examples, the storage device may obtain an XOR 108 of the first read and the second read (e.g., to identify addresses of conflicts in bit values read between the read 102 and the read 104 of FIG. 1A), an XOR 110 of the first read and the third read (e.g., to identify addresses of conflicts between the read 102 and the read 106 of FIG. 1A), and an XOR 112 of the second read and the third read (e.g., to identify addresses of conflicts between the read 104 and the read 106 of FIG. 1A).

For example, for state X, the first sensing read uses Vₓ(1), the second uses Vₓ(2), and the third uses Vₓ(3). As shown in FIG. 1B, the storage device may “XOR” the data read-out from Vₓ(1) with the data read-out from Vₓ(2), as well as Vₓ(2) with Vₓ(3), and Vₓ(1) with Vₓ(3). This way, the storage device may identify the bits that fall between Vₓ(1) and Vₓ(2), and Vₓ(2) and Vₓ(3), (e.g., to determine the overlaps). So, the storage device may compare overlaps and determine where an improved read level should be to reduce overlap.

In some aspects, the storage device (e.g., a controller) may obtain three BERs from reads 1, 2, and 3, identified as BER₁, BER₂, and BER₃, respectively, via normal error detection for data reads. The storage device may determine non-overlapped error bit counts by using an XOR operation on the read data. This provides the storage device with a total amount of the XOR bits, XOR(x)+XOR(y), and their associated address locations (e.g., where in a data set the errors occurred. For example, the XOR operation will show bits that have the same values. So, by counting the XOR “1” or “0” bit, the storage device determines how many errors there are. The storage device may not initially be able to identify whether detected errors came from Sₓ or S_{y}.

In some aspects, the storage device may perform a single state read between the Sₓ state and the S_{y} state (e.g., where only S_{y} or Sₓ are possible outcomes) and, based on location addresses of 1s and 0s (e.g., bit values identified in the single state read) and matching XOR(x) and XOR(y) addresses (e.g., where the different reads associated with different Vₓ values or V_{y} conflict), identify which bits of the XOR operation are from the XOR(x) and which bits are from the XOR(y). For example, when the storage device performs a sensing operation, the storage device may determine which bit is from which bitline. So, the address is a record of where the bits are located in the NAND bitlines. Alternatively, the storage device may assume that 50% of the XOR bits are from identification of bit values as being associated with the Sₓ state and 50% are from identification of bit values as being associated with the S_{y} state, as an approximation. This is a logical reasoning to have an assignment for the bits that could be belonging to State X (Sx) or state Y (Sy) without any further info.

The storage device may obtain a total quantity of the XOR bits and associated address locations and may combine this with the XOR(x) and XOR(y) bit locations to produce constructed reads shown in FIGS. 1C-1E.

As shown in FIG. 1C, the storage device may obtain Read 1_2 114 and Read 2_1 116. For Read 1_2 114, the storage device may keep Read 1 data (from Read 102) associated with Vₓ and use Read 2 data (from Read 104) from the addresses of the XOR(y) bits (associated with the XOR 108 for the Vy threshold). For example, the storage device may use bit values from the Read 1 data where Read 1 and Read 2 disagree in association with Vx and may use Read 2 data where Read 1 and Read 2 disagree in association with Vy.

For Read 2_1 116, the storage device may keep Read 2 data associated with Vₓ and use Read 1 data from the addresses of the XOR(x) bits and use this Read 1 data for Read 2_1 at locations where Read 1 and Read 2 disagree in association with a read state near the V_{y} threshold. For example, the storage device may use bit values from the Read 2 data associated with the V_{y} threshold where the XOR 108 has a first value (e.g., 0 associated with agreement between Read 1 and Read 2) and may use bit values from the Read 1 data associated with the V_{y} threshold where the XOR 108 has a second value (e.g., 1 associated with disagreement).

In this way, two additional reads may be constructed without actually performing read operations (e.g., without performing sensing on the hardware (e.g., the non-volatile memory device)). This may conserve power and computing resources, and may reduce a cycle count of the storage device, which may improve longevity of the storage device.

In some aspects, the storage device may construct additional reads based at least in part on additional combinations involving a third read (Read 106). For example, the storage device may perform three reads as part of a soft bit read (SBR), including a hard bit read and two SBRs). In a manner similar to that described for Read 1 and Read 2, above, the storage device may use different combinations of actual read data and XOR data from combining one or more of the reads to generate 6 constructed reads to add to the three reads.

As shown in FIG. 1D, the storage device may obtain Read 1_3 118 and Read 3_1 120. For Read 1_3 118, the storage device may keep Read 1 data (from Read 102) for read data associated with Vₓ and use Read 3 data (from Read 106) from the addresses of the XOR(y) bits (associated with the XOR 110 for the V_{y} threshold). For example, the storage device may use bit values from the Read 1 data where Read 1 and Read 3 disagree relative to the Vₓ threshold (e.g., based at least in part on the XOR 110 having a first value and may use bit values from the Read 3 data where the XOR 110 has a second value associated with a disagreement relative to the V_{y} threshold.

For Read 3_1 120, the storage device may keep Read 3 data for read data associated with Vₓ and use Read 1 data (from Read 102) for read data associated with V_{y} at the addresses of the XOR(x) bits that indicate a disagreement associated with Vy.

As shown in FIG. 1E, the storage device may obtain Read 2_3 122 and Read 3_2 124. For Read 2_3 122, the storage device may keep Read 2 data (from Read 104) for read data associated with Vₓ and use Read 3 data (from Read 106) for read data associated with V_{y} at the addresses of the XOR(y) bits (associated with the XOR 112 for the V_{y} threshold) that indicate a disagreement associated with Vy.

For Read 3_2 124, the storage device may keep Read 3 data (from Read 106) for read data associated with Vₓ and use Read 2 data (from Read 104) for read data associated with V_{y} at the addresses of the XOR(y) bits (associated with the XOR 110 for the V_{y} threshold) that indicate a disagreement associated with Vy.

Using the operations described herein, the storage device may determine bit count results without having to actually sense and read the NAND. Rather, the storage device may use the previous schemes (e.g., sensing three times, XOR the results, and deducing the bits belonging, and determine which read levels are optimum).

The storage device may use an LDPC or other error correction to identify a read level having a reduced BER among all read levels (e.g., the actual reads and the constructed reads). In this way, the storage device may read the data three times, obtain nine read values from the three reads, and use the nine read values to identify a redefined (e.g., improved) read value in a way that reduces time and improves QoS.

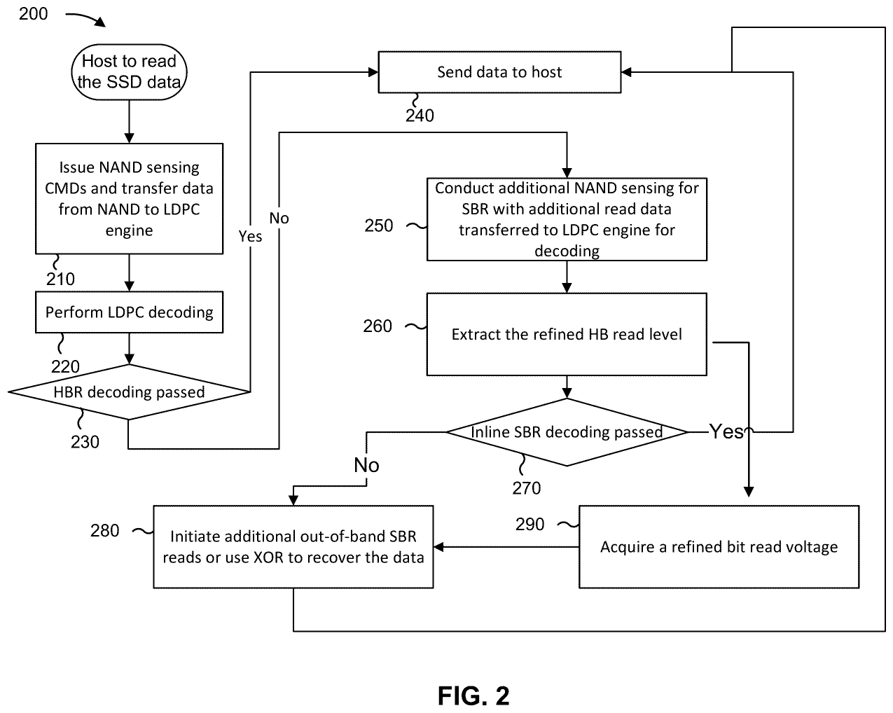

FIG. 2 is a diagram of an example 200 of refining hard bit read voltages described herein. The operations described in connection with example 200 may be performed by one or more of a controller or application specific integrated circuit (ASIC), among other examples. Although described in connection with FIG. 2 as an SSD or NAND device, other storage devices are intended to be interchangeable in the context of the described aspects and examples.

As shown in FIG. 2, a host device may initiate a read operation. For example, a controller of a storage device may receive, from the host device, a read command. At block 210, the controller (e.g., a flash controller) may issue sensing commands and data may be transferred from the memory device to an LDPC engine. For example, the controller may issue a sensing command to sense a voltage at one or more cells of a storage medium of the storage device. At block 220, the controller of the SSD may initiate LDPC decoding (or other error correction) to decode data from the results of the flash sensing.

If an HBR decoding passes, at block 240, the data may be sent to the host device. For example, the HBR decoding may pass if the decoded data is determined to be free from errors (e.g., possibly after error correction). However, if the HBR decoding fails (e.g., hard decisions on sensed voltages being associated with bit values produces errors that are not corrected in the HBR process, or identifying a 0.7% bit failure rate beyond which the HBR may fail the decoding), the controller may initiate SBR operations. The controller may decide if the SBR should be conducted after HBR results are known. Once SBR is conducted, the results are used to further extract the optimum read levels for the new HBR level.

As part of the SBR operations, at block 250, the controller may initiate additional sensing to obtain additional reads of the data, and the additional read data may be transferred to the LDPC engine for decoding. Additionally, at block 260, the controller may extract a refined hard bit read level. For example, the controller may identify a hard bit read voltage, from actual reads (e.g., associated with the additional sensing and original sensing) and constructed reads using combinations of elements from actual reads and XOR values from combinations of reads (e.g., as described in connection with FIGS. 1A-1E). In some aspects, starting HBR levels may be based on a given NAND technology, and the storage device may use a trial-and-error approach to improve the HBR that gives a minimum BER.

At block 270, the controller may determine whether the inline SBR decoding (e.g., SBR decoding during a current read operation, such as using XOR internal to a storage medium) passed. If the inline SBR does not pass, at block 280, the controller may initiate out-of-band SBR reads (e.g., SBR decoding outside of a current read operation or between read operations, sometimes used after inline SBR decoding fails, such as performing XOR on data by the controller) or use XOR operations to recover the data. Each read may be followed by an error correction code decoding engine such as using an LDPC device. For example, out-of-band SBR reads or XOR operations (e.g., as described in connection with FIGS. 1A-1E) may be used to test various read voltage thresholds (e.g., “bit read thresholds” or “read voltages” among other examples) to find improved reads (e.g., with reduced errors) In some aspects, the out-of-band SBR reads may cause a QoS penalty based on a latency of the additional out-of-band SBR reads. If the data is recoverable, the controller may send the data to the host. If the inline SBR decoding passed, the controller may send the data to the host device.

At block 290, the controller may acquire a refined hard bit read voltage from the extracted refined hard bit read voltage (e.g., the same as extracted or with a modification) and may set the refined hard bit read voltage as the hard bit read voltage for a subsequent read operation. For example, the refined hard bit read voltage may be set as the hard bit read voltage until a further refinement occurs in a similar process as described herein.

The number and arrangement of components shown in FIG. 2 are provided as an example.

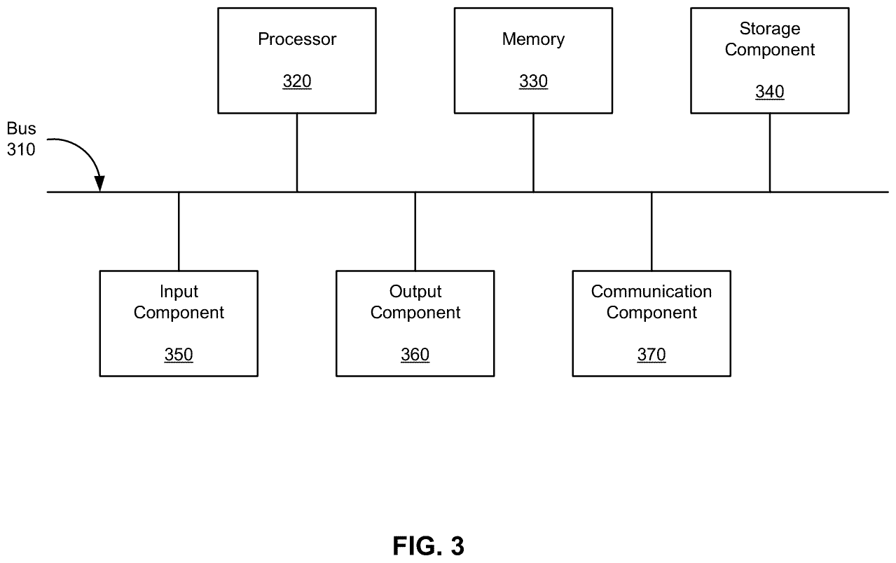

FIG. 3 is a diagram of example components of a device 300, which may correspond to one or more devices used in conjunction with FIG. 1 or 2, such as a controller or application specific integrated circuit (ASIC). In some implementations, the controller or ASIC may include one or more devices 300 and one or more components of device 300. As shown in FIG. 3, device 300 may include a bus 310, a processor 320, a memory 330, a storage component 340, an input component 350, an output component 360, and a communication component 370.

Bus 310 includes a component that enables wired or wireless communication among the components of device 300. Processor 320 includes a central processing unit, a graphics processing unit, a microprocessor, a controller, a microcontroller, a digital signal processor, a field-programmable gate array, an application-specific integrated circuit, or another type of processing component. Processor 320 is implemented in hardware, firmware, or a combination of hardware and software. In some implementations, processor 320 includes one or more processors capable of being programmed to perform a function. Memory 330 includes a random access memory (RAM), a read only memory, or another type of memory (e.g., a flash memory, a magnetic memory, or an optical memory).

Storage component 340 stores information or software related to the operation of device 300. For example, storage component 340 may include a hard disk drive, a magnetic disk drive, an optical disk drive, a solid state disk drive, a compact disc, a digital versatile disc, or another type of non-transitory computer-readable medium. Input component 350 enables device 300 to receive input, such as user input or sensed inputs. For example, input component 350 may include a touch screen, a keyboard, a keypad, a mouse, a button, a microphone, a switch, a sensor, a global positioning system component, an accelerometer, a gyroscope, or an actuator. Output component 360 enables device 300 to provide output, such as via a display, a speaker, or one or more light-emitting diodes. Communication component 370 enables device 300 to communicate with other devices, such as via a wired connection or a wireless connection. For example, communication component 370 may include a receiver, a transmitter, a transceiver, a modem, a network interface card, or an antenna.

Device 300 may perform one or more processes described herein. For example, a non-transitory computer-readable medium (e.g., memory 330 or storage component 340) may store a set of instructions (e.g., one or more instructions, code, software code, or program code) for execution by processor 320. Processor 320 may execute the set of instructions to perform one or more processes described herein. In some implementations, execution of the set of instructions, by one or more processors 320, causes the one or more processors 320 or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

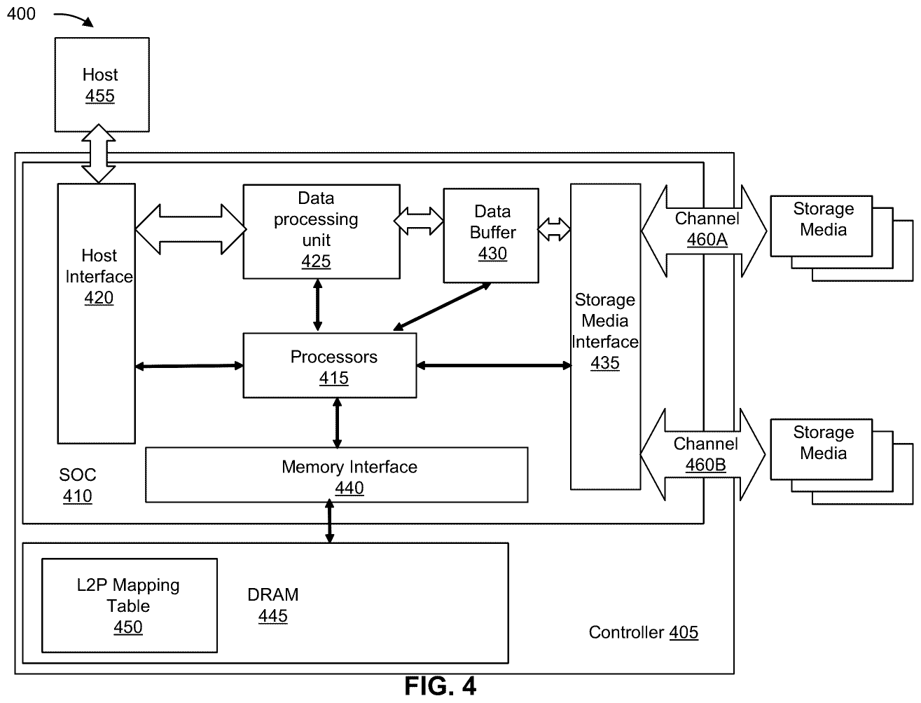

FIG. 4 is a diagram of example components of a storage device 400, which may correspond to one or more devices of FIG. 1, FIG. 2 or FIG. 3.

As shown in FIG. 4, the storage device 400 may include a controller 405 (e.g., an SSD controller). The controller 405 may include a system on chip (SOC) 410. The SOC 410 may perform computing or processing operations for the controller 405. The SCO may include one or more processors 415 that control, command, or observe operations at one or more other components of the SOC 410. The one or more processors 415 may be communicably coupled to one or more of a host interface 420, a data processing unit (DPU) 425, a data buffer 430, a storage medium interface 435, or a memory interface 440.

The host interface 410 may be configured to communicate with a host device (e.g., host device 455 described below). The DPU 425 may include a functional block that is responsible for managing data operations, such as reading, writing, error correction, or formatting (e.g., data flow between a host interface and a storage medium). The DPU 425 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples. The data buffer 430 may include a temporary storage area used to transfer or process data between the storage media and a host system. The data buffer 430 is a pipeline data buffer for the data transition. The memory interface 440 may provide an interface between the SOC 410 and the DRAM 445 to facilitate transfers of information. For example, the memory interface 440 (e.g., an interface between the controller and an external DDR or DRAM to temporarily hold the data) may support requests to access a logical to physical (L2P) mapping table to identify a physical location of data requested by the host device, or to provide mapping information for storage in the L2P mapping table.

The controller 405 may further include DRAM 445. The DRAM 445 may locally store information that is available on demand at the controller 405 for operations of the controller 405. For example, the DRAM 445 may store an L2P mapping table 450 that maps logical locations of data and physical locations of data on connected storage media. In this way, the controller 405 may have access to mapping information for locating data on the connected storage media based at least in part on an indication associated with host data when written.

The host interface 420 may provide an interface for communicating with a host 455. For example, the host interface 420 may receive an access request or data for storage on connected storage media. In some aspects, the host interface 420 may provide data to the host after reading the data on from the connected storage media.

The storage media interface 435 may communicate via one or more channels 460 (e.g., 460A and 460B) with one or more connected storage media 465 (e.g., 465A and 465B). For example, the controller 405 may perform or initiate a read or write operation at a physical location of a storage media device 465.

The number and arrangement of components shown in FIG. 4 are provided as an example.

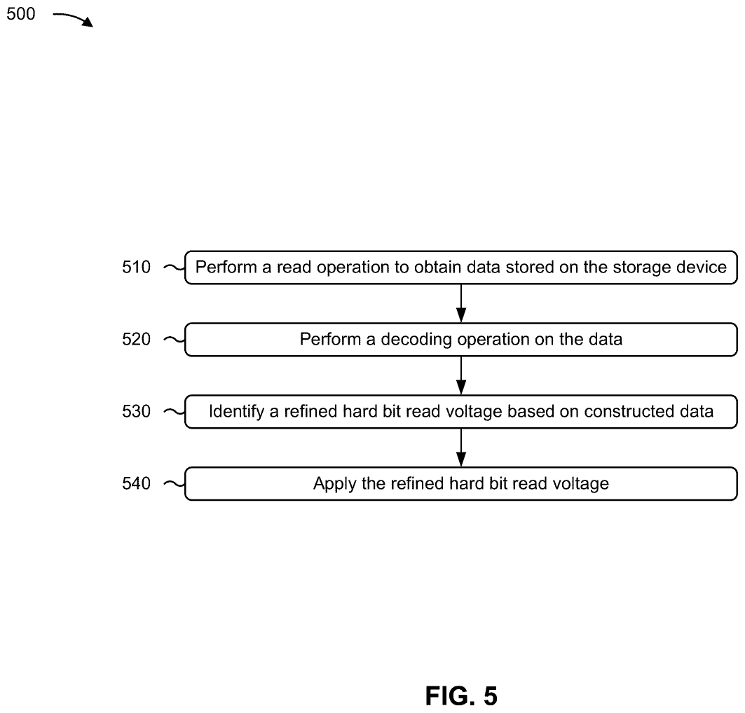

FIG. 5 is a flowchart of an example process 500 associated with refined hard bit read voltages. In some implementations, one or more process blocks of FIG. 5 may be performed by a storage device (e.g., a non-volatile memory device, a controller of the storage device, among other examples). In some implementations, one or more process blocks of FIG. 5 may be performed by another device or a group of devices separate from or including the storage device. Additionally, or alternatively, one or more process blocks of FIG. 5 may be performed by one or more components of device 300, such as processor 320, memory 330, storage component 340, input component 350, output component 360, or communication component 370. Additionally, or alternatively, one or more process blocks of FIG. 5 may be performed by one or more components of FIG. 3, such as controller 405, SOC 410, processors 415, or storage media interface 435.

As shown in FIG. 5, process 500 may include performing a read operation to obtain data stored on the storage device (block 510). For example, the storage device may perform a read operation to obtain data stored on the storage device, as described above. In some implementations, the storage device comprises an SSD. In some implementations, the storage device comprises a controller that includes one or more of an ASIC or firmware configured to perform operations on the storage device.

As further shown in FIG. 5, process 500 may include performing a decoding operation on the data (block 520). For example, the storage device may perform a decoding operation on the data, as described above. In some implementations, performing the decoding operation on the data comprises attempting a hard bit read operation using a hard bit read voltage, and performing a soft bit read operation based on failure of the hard bit read operation using the hard bit read voltage.

As further shown in FIG. 5, process 500 may include identifying a refined hard bit read voltage based on constructed data (block 530). For example, the storage device may identify a refined hard bit read voltage based on constructed data, as described above.

As further shown in FIG. 5, process 500 may include applying the refined hard bit read voltage (block 540). For example, the storage device may apply the refined hard bit read voltage, as described above. In some implementations, the hard bit read voltage is associated with one or more of a default hard bit read voltage, or a previously refined hard bit read voltage associated with a previous read operation. In some implementations, the refined hard bit read voltage is an analog value of voltage associated with determining a bit value of a sensed voltage of the storage device.

Process 500 may include additional implementations, such as any single implementation or any combination of implementations described below or in connection with one or more other processes described elsewhere herein (e.g., processes 600 or 700, among other examples). In some implementations, process 500 includes providing the constructed data to an associated host device after the decoding operation.

In some implementations, process 500 includes performing a subsequent read operation, and performing a subsequent decoding operation using the refined hard bit read voltage. In some implementations, process 500 includes performing one or more of an erase operation or a write operation before performing the subsequent decoding operation.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

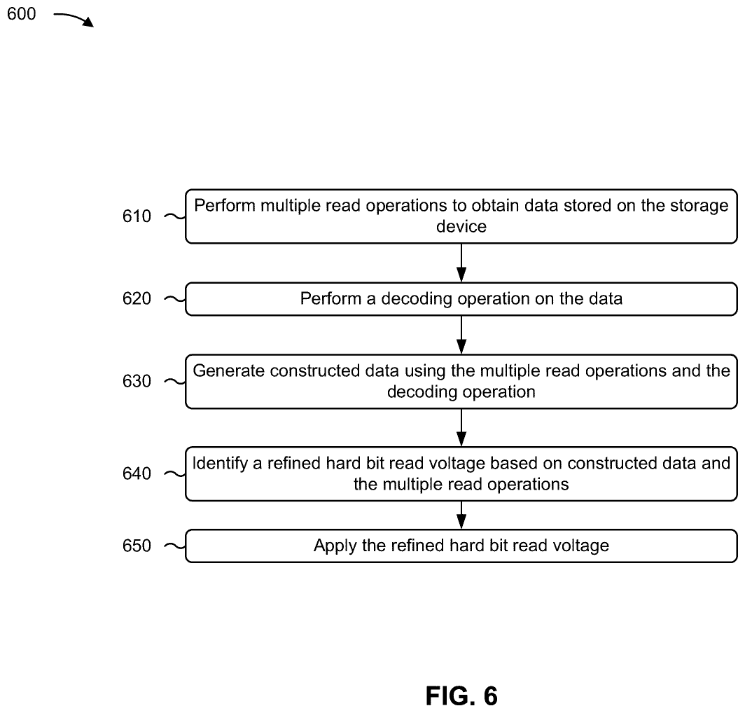

FIG. 6 is a flowchart of an example process 600 associated with refined hard bit read voltages. In some implementations, one or more process blocks of FIG. 6 may be performed by a storage device (e.g., a non-volatile memory device, a controller of the storage device, among other examples). In some implementations, one or more process blocks of FIG. 6 may be performed by another device or a group of devices separate from or including the storage device. Additionally, or alternatively, one or more process blocks of FIG. 6 may be performed by one or more components of device 300, such as processor 320, memory 330, storage component 340, input component 350, output component 360, or communication component 370. Additionally, or alternatively, one or more process blocks of FIG. 6 may be performed by one or more components of FIG. 3, such as controller 405, SOC 410, processors 415, or storage media interface 435.

As shown in FIG. 6, process 600 may include performing multiple read operations to obtain data stored on the storage device (block 610). For example, the storage device may perform multiple read operations to obtain data stored on the storage device, as described above.

As further shown in FIG. 6, process 600 may include performing a decoding operation on the data (block 620). For example, the storage device may perform a decoding operation on the data, as described above.

As further shown in FIG. 6, process 600 may include generating constructed data using the multiple read operations and the decoding operation (block 630). For example, the storage device may generate constructed data using the multiple read operations and the decoding operation, as described above.

As further shown in FIG. 6, process 600 may include identifying a refined hard bit read voltage based on constructed data (block 640). For example, the storage device may identify a refined hard bit read voltage based on constructed data, as described above.

As further shown in FIG. 6, process 600 may include applying the refined hard bit read voltage (block 650). For example, the storage device may apply the refined hard bit read voltage, as described above.

In some implementations, process 600 includes (e.g., in connection with performing the multiple read operations), attempting a hard bit read operation using a hard bit read voltage, and performing a soft bit read operation based on failure of the hard bit read operation.

In some implementations, the refined hard bit read voltage is an analog value of voltage associated with determining a bit value of a sensed voltage of the storage device.

In some implementations, process 600 includes performing a subsequent read operation and performing a subsequent decoding operation using the refined hard bit read voltage.

In some implementations, process 600 includes generating the constructed data without performing read operations.

In some implementations, process 600 includes providing the constructed data to an associated host device after the decoding operation.

In some implementations, process 600 includes (in connection with generating the constructed data), identifying locations of conflicting bit values between a first read operation and a second read operation and generating the constructed data to include bit values of the first read operation at locations without conflicting bit values and to include bit values of the second read operation at locations having conflicting bit values.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

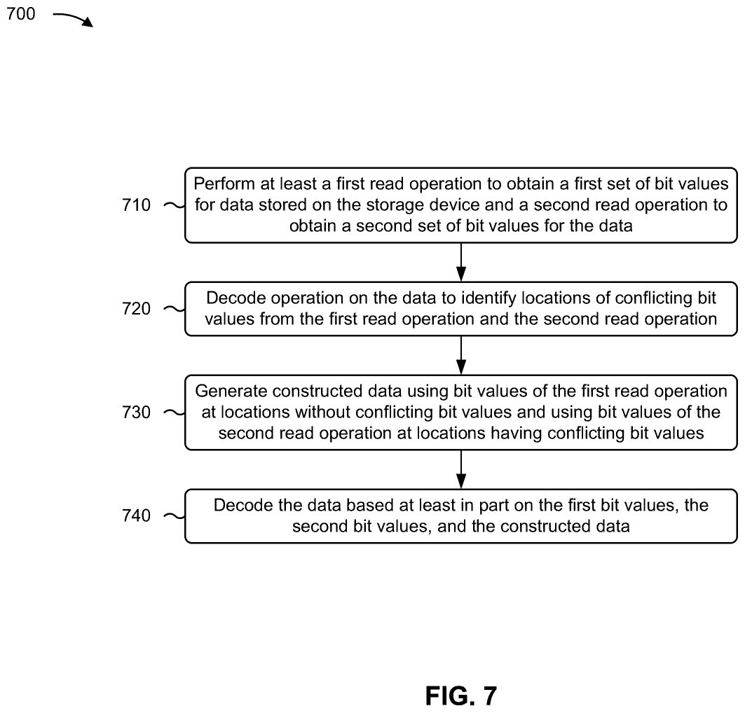

Although FIG. 6 shows example blocks of process 600, in some implementations, process 600 may include additional blocks, fewer blocks, different blocks, or differently arranged blocks than those depicted in FIG. 6. For example, process 600 may include one or more of implementations described in connection with FIG. 5 or FIG. 7. Additionally, or alternatively, two or more of the blocks of process 600 may be performed in parallel.

FIG. 7 is a flowchart of an example process 700 associated with refined hard bit read voltages. In some implementations, one or more process blocks of FIG. 7 may be performed by a storage device (e.g., a non-volatile memory device, a controller of the storage device, among other examples). In some implementations, one or more process blocks of FIG. 7 may be performed by another device or a group of devices separate from or including the storage device. Additionally, or alternatively, one or more process blocks of FIG. 7 may be performed by one or more components of device 300, such as processor 320, memory 330, storage component 340, input component 350, output component 360, or communication component 370. Additionally, or alternatively, one or more process blocks of FIG. 7 may be performed by one or more components of FIG. 3, such as controller 405, SOC 410, processors 415, or storage media interface 435.

As shown in FIG. 7, process 700 may include performing at least a first read operation to obtain a first set of bit values for data stored on the storage device and a second read operation to obtain a second set of bit values for the data (block 710). For example, the storage device may perform at least a first read operation to obtain a first set of bit values for data stored on the storage device and a second read operation to obtain a second set of bit values for the data, as described above.

As further shown in FIG. 7, process 700 may include performing a decoding operation on the data to identify locations of conflicting bit values from the first read operation and the second read operation (block 720). For example, the storage device may decode operation on the data to identify locations of conflicting bit values from the first read operation and the second read operation, as described above.

As further shown in FIG. 7, process 700 may include generating constructed data using bit values of the first read operation at locations without conflicting bit values and using bit values of the second read operation at locations having conflicting bit values (block 730). For example, the storage device may generate constructed data using bit values of the first read operation at locations without conflicting bit values and using bit values of the second read operation at locations having conflicting bit values, as described above.

As further shown in FIG. 7, process 700 may include decoding the data based at least in part on the first bit values, the second bit values, and the constructed data (block 740). For example, the storage device may decode the data based at least in part on the first bit values, the second bit values, and the constructed data, as described above.

Process 700 may include additional implementations, such as any single implementation or any combination of implementations described below and/or in connection with one or more other processes described elsewhere herein.

In some implementations, process 700 includes generating additional constructed data using bit values of the second read operation at locations without conflicting bit values and using bit values of the first read operation at locations having conflicting bit values.

Although FIG. 7 shows example blocks of process 700, in some implementations, process 700 may include additional blocks, fewer blocks, different blocks, or differently arranged blocks than those depicted in FIG. 7. For example, process 700 may include one or more of implementations described in connection with FIG. 5 or FIG. 6. Additionally, or alternatively, two or more of the blocks of process 700 may be performed in parallel.

While the foregoing examples have been described with respect to NAND flash memory device, implementations described therein may applicable devices that may need the error code comparison with addressable locality can be applied to. For example, implementations described herein may be applicable to a hard disk drive (HDD) or NOR flash device, or RAM, imaging sensor, graphic chip (e.g., graphical processing unit (GPU)), where the addressing is applied.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code-it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a storage device, the method comprising:
performing a read operation to obtain data stored on the storage device;
performing a decoding operation on the data;
identifying a refined hard bit read voltage based on constructed data; and
applying the refined hard bit read voltage.

2. The method of claim 1, wherein performing the decoding operation on the data comprises attempting a hard bit read operation using a hard bit read voltage; and
performing a soft bit read operation based on failure of the hard bit read operation using the hard bit read voltage.

3. The method of claim 2, wherein the hard bit read voltage is associated with one or more of:
a default hard bit read voltage, or
a previously refined hard bit read voltage associated with a previous read operation.

4. The method of claim 2, wherein the constructed data comprises data constructed based on the soft bit read operation.

5. The method of claim 1, wherein the refined hard bit read voltage is an analog value of voltage associated with determining a bit value of a sensed voltage of the storage device.

6. The method of claim 1, comprising:
performing a subsequent read operation; and
performing a subsequent decoding operation using the refined hard bit read voltage.

7. The method of claim 6, comprising:
combine read data and XOR data to generate the constructed data.

8. The method of claim 6, wherein performing the decoding operation comprises performing a soft bit read operation based on failure of a hard bit read operation using a hard bit read voltage, and
wherein performing the subsequent decoding operation comprises successfully performing a hard bit read operation without a soft bit read operation.

9. The method of claim 1, wherein the storage device comprises a solid state drive (SSD).

10. The method of claim 1, wherein the storage device comprises a controller that includes one or more of an application specific integrated circuit (ASIC) or firmware configured to perform operations on the storage device.

11. The method of claim 1, comprising:
providing the constructed data to an associated host device after the decoding operation.

12. A system comprising:
a controller, of a non-volatile memory device, to:
perform multiple read operations to obtain data stored on the storage device;
perform a decoding operation on the data;
generate constructed data using the multiple read operations and the decoding operation;
identify a refined hard bit read voltage based on constructed data; and
apply the refined hard bit read voltage.

13. The system of claim 12, wherein, to perform the multiple read operations, the controller is to:
attempt a hard bit read operation using a hard bit read voltage; and
perform a soft bit read operation based on failure of the hard bit read operation.

14. The system of claim 12, wherein the refined hard bit read voltage is an analog value of voltage associated with determining a bit value of a sensed voltage of the storage device.

15. The system of claim 12, wherein the controller is to:
perform a subsequent read operation; and
perform a subsequent decoding operation using the refined hard bit read voltage.

16. The system of claim 12, wherein the controller is to:
generate the constructed data without performing read operations.

17. The system of claim 12, wherein the controller is to:
provide the constructed data to an associated host device after the decoding operation.

18. The system of claim 12, wherein generating the constructed data comprises:
identifying locations of conflicting bit values between a first read operation and a second read operation; and
generating the constructed data to include bit values of the first read operation at locations without conflicting bit values and to include bit values of the second read operation at locations having conflicting bit values.

19. A computer program product comprising:
one or more computer readable storage media, and program instructions collectively stored on the one or more computer readable storage media, the program instructions comprising:
program instructions to perform at least a first read operation to obtain a first set of bit values for data stored on the storage device and a second read operation to obtain a second set of bit values for the data;
program instructions to perform a decoding operation on the data to identify locations of conflicting bit values from the first read operation and the second read operation;
program instructions to generate constructed data using bit values of the first read operation at locations without conflicting bit values and using bit values of the second read operation at locations having conflicting bit values;
program instructions to decode the data based at least in part on the first bit values, the second bit values, and the constructed data.

20. The computer program product of claim 19, wherein the program instructions comprise:
program instructions to generate additional constructed data using bit values of the second read operation at locations without conflicting bit values and using bit values of the first read operation at locations having conflicting bit values.
